(19) United States
(12) Patent Application Publication
(10) Pub. No.: US 2006/0291861 A1
(43) Pub. Date: Dec. 28, 2006

(54) WDM PON with interleaver

(75) Inventors: Sung-Bum Park, (US); Seong-Taek Hwang, (US)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/442,038

(22) Filed: May 26, 2006

(30) Foreign Application Priority Data
Jun. 23, 2005 (KR) 2005-54510

(51) Int. Cl. H04J 14/00

(52) U.S. Cl. 398/71

(57) ABSTRACT

A WDM PON includes: a CO for transmitting downstream optical signals; a RN for distributing the downstream optical signals received from the CO; and a SUB for receiving the distributed downstream optical signals. The CO includes: BiDis of a first group for outputting data-modulated downstream optical signals of the first group; BiDis of a second group for outputting data-modulated downstream optical signals of the second group band; a DBLS for outputting downstream light; and an interleaver for generating the downstream injection light of the first and the second groups by spectrum-slicing and deinterleaving the downstream light, providing the downstream injection light of the first group to the BiDis of the first group, and providing the downstream injection light of the second group to the BiDis of the second group.

### CLAIM OF PRIORITY

This application claims priority to an application entitled “WDM PON With Interleaver,” filed in the Korean Intellectual Property Office on Jun. 23, 2005 and assigned Ser. No. 2005-54510, the contents of which are hereby incorporated by reference.

### BACKGROUND OF THE INVENTION

1. Field of the Invention

The present invention relates to a Passive Optical Network (PON), and more particularly to a Wavelength Division Multiplexed (WDM) PON using a wavelength-locked optical transceiver.

2. Description of the Related Art

A PON corresponds to a communication network in which a Central Office (CO) is connected to a subscriber-side device through an optical fiber for exchange of optical signals. A PON can provide broadcasting information, ultra high speed information, and separate communication services required by each subscriber. A PON has a star structure, connects a CO to a Remote Node (RN), which is installed in an area adjacent to subscribers, through one Feeder Fiber (FF), and connects the RN to subscriber-side devices through a plurality of Distribution Fibers (DFs).

In a PON, it is important to reduce necessary cost per subscriber in the process of constructing the PON. To achieve this, research into a wavelength-locked optical transceiver, which has a wavelength of injected light and directly outputs modulated optical signals, has been actively conducted. For example, a wavelength-locked optical transceiver may include a Fabry-Perot laser diode, a reflective semiconductor optical amplifier, etc. In order to use such a wavelength-locked optical transceiver, a broadband light source is necessary and important to properly dispose such a broadband light source.

FIG. 1 is a block diagram illustrating a WDM PON using a conventional wavelength-locked optical transceiver. As shown, the PON 100 includes a CO 110, a RN 180 connected to the CO 110 through an FF 170, and a subscriber-side device (SUB) 210 connected to the RN 180 through first to N^{th} DFs 200-1 to 200-N.

The CO 110 includes first to N^{th} Bidirectional optical transceivers (BiDis) 120-1 to 120-N of a first group, a first Wavelength Division Multiplexer (WDM) 130, a Downstream Broadband Light Source (DBLS) 140, an Upstream Broadband Light Source (UBLS) 150, and an optical Coupler (CP) 160. The RN 180 includes a second WDM 190. The SUB 210 includes first to N^{th} BiDis 220-1 to 220-N of a second group.

Hereinafter, a downstream transmission process in the PON 100 will be described.

Downstream light output from the DBLS 140 is input to a Multiplexing Port (MP) of the WDM 130 after passing through the CP 160. The WDM 130 spectrum-slices the input downstream light so as to generate first to N^{th} downstream injection light, and sequentially inputs the first to the N^{th} downstream injection light to the first to the N^{th} BiDos 120-1 to 120-N of the first group in a one-to-one fashion through first to N^{th} Demultiplexing Ports (DPs). The first to the N^{th} BiDis 120-1 to 120-N of the first group output first to N^{th} data-modulated downstream optical signals generated by the first to the N^{th} input downstream injection light. The WDM 130 multiplexes and outputs the first to the N^{th} input downstream optical signals, and the multiplexed downstream optical signals are input to the second WDM 190 after passing through the CP 160 and the FF 170.

The second WDM 190 demultiplexes the multiplexed downstream optical signals input from the FF 170, and outputs the demultiplexed downstream optical signals through the first to the N^{th} DPs. The first to the N^{th} downstream optical signals output from the second WDM 190 are sequentially input to the first to the N^{th} BiDis 220-1 to 220-N of the second group in a one-to-one fashion through the first to the N^{th} DFs 200-1 to 200-N. The first to the N^{th} BiDis 220-1 to 220-N of the second group convert the first to the N^{th} input downstream optical signals into electrical signals.

Hereinafter, an upstream transmission process in the PON 100 will be described.

Upstream light output from the UBLS 150 is input to the second WDM 190 after passing through the CP 160 and the FF 170. The second WDM 190 spectrum-slices the upstream light input to an MP so as to generate first to N^{th} upstream injection light, and sequentially outputs the first to the N^{th} upstream injection light in a one-to-one fashion through the first to the N^{th} DPs. The first to the N^{th} upstream injection light output from the second WDM 190 are sequentially input to the first to the N^{th} BiDis 220-1 to 220-N of the second group in a one-to-one fashion after passing through the first to the N^{th} DFs 200-1 to 200-N. The first to the N^{th} BiDis 220-1 to 220-N of the second group output first to N^{th} data-modulated upstream optical signals generated by the first to the N^{th} input upstream injection light.

The second WDM 190 multiplexes and outputs the first to the N^{th} input upstream optical signals, and the multiplexed upstream optical signals are input to the WDM 130 after passing through the FF 170 and the CP 160. The WDM 130 demultiplexes the multiplexed upstream optical signals input to the MP, and sequentially outputs the demultiplexed upstream optical signals the first to the N^{th} BiDis 120-1 to 120-N of the first group in a one-to-one fashion through the first to the N^{th} DPs. The first to the N^{th} BiDis 120-1 to 120-N of the first group convert the first to the N^{th} input upstream optical signals into electrical signals.

However, the conventional PON 100 as described above has poor expansibility. That is, in order to accommodate new subscribers, the PON 100 must replace the existing WDMs 130 and 190 with a new WDM having an increased number of DPs corresponding to the number of subscribers. Further, it is necessary to add a new BLS or to replace the existing BLSs 140 and 150 with a new BLS having a wider bandwidth.

Therefore, it is necessary to provide a PON capable of accommodating many subscribers more economically and efficiently.

### SUMMARY OF THE INVENTION

Accordingly, the present invention has been made to solve the above-mentioned problems occurring in the prior art and provides additional advantages, by providing a WDM PON capable of accommodating many subscribers more economically and efficiently as compared with the prior art.

In accordance with one aspect of the present invention, there is provided a Wavelength Division Multiplexed (WDM) Passive Optical Network (PON), which includes: a Central Office (CO) for transmitting downstream optical signals; a Remote Node (RN) for distributing the downstream optical signals received from the CO; and a subscriber-side device (SUB) for receiving the distributed downstream optical signals, wherein the CO includes: Bidirectional optical transceivers (BiDis) of a first group for outputting data-modulated downstream optical signals of the first group generated by downstream injection light of the first group, which belongs to a first wavelength group of a downstream band; BiDis of a second group for outputting data-modulated downstream optical signals of the second group generated by downstream injection light of the second group, which belong to a second wavelength group alternatively disposed with the first wavelength group more than twice within the downstream band; a Downstream Broadband Light Source (DBLS) for outputting downstream light; and an interleaver for generating the downstream injection light of the first and the second groups by spectrum-slicing and deinterleaving the downstream light, providing the downstream injection light of the first group to the BiDis of the first group, and providing the downstream injection light of the second group to the BiDis of the second group.

### BRIEF DESCRIPTION OF THE DRAWINGS

The above features and advantages of the present invention will be more apparent from the following detailed description taken in conjunction with the accompanying drawings, in which:

FIG. 1 is a block diagram illustrating a WDM PON using a conventional wavelength-locked optical transceiver;

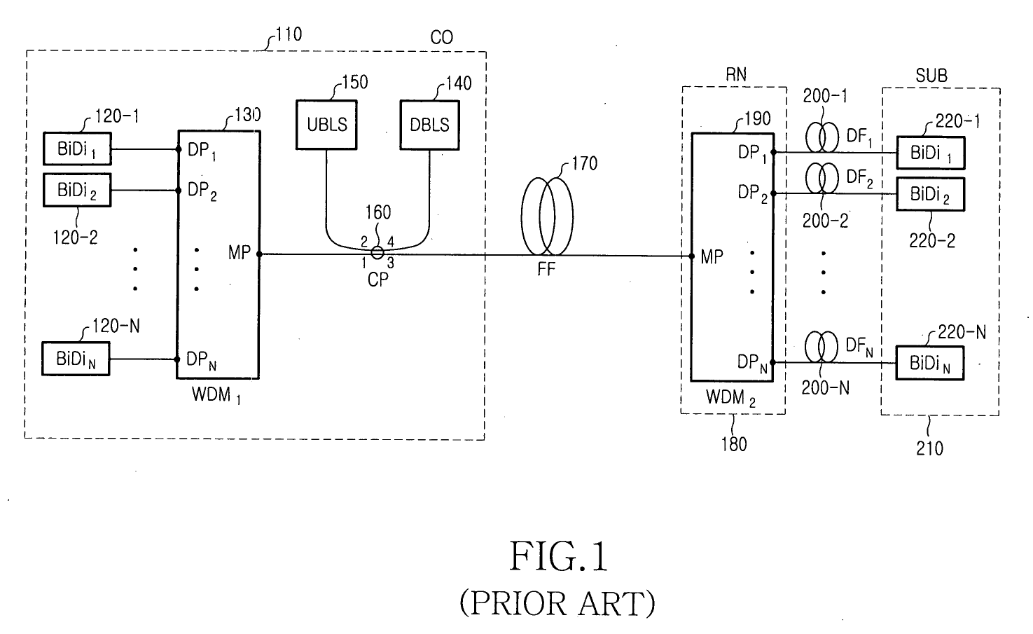

FIG. 2 is a block diagram illustrating a WDM PON according to an embodiment of the present invention;

FIG. 3 is a diagram illustrating downstream and upstream transmission bands used in the PON shown in FIG. 2; and

FIG. 4 is a diagram illustrating input and output characteristics of the interleaver shown in FIG. 2.

### DETAILED DESCRIPTION

An embodiment of the present invention will be described in detail herein below with reference to the accompanying drawings. For the purposes of clarity and simplicity, a detailed description of known functions and configurations incorporated herein will be omitted as it may obscure the subject matter of the present invention.

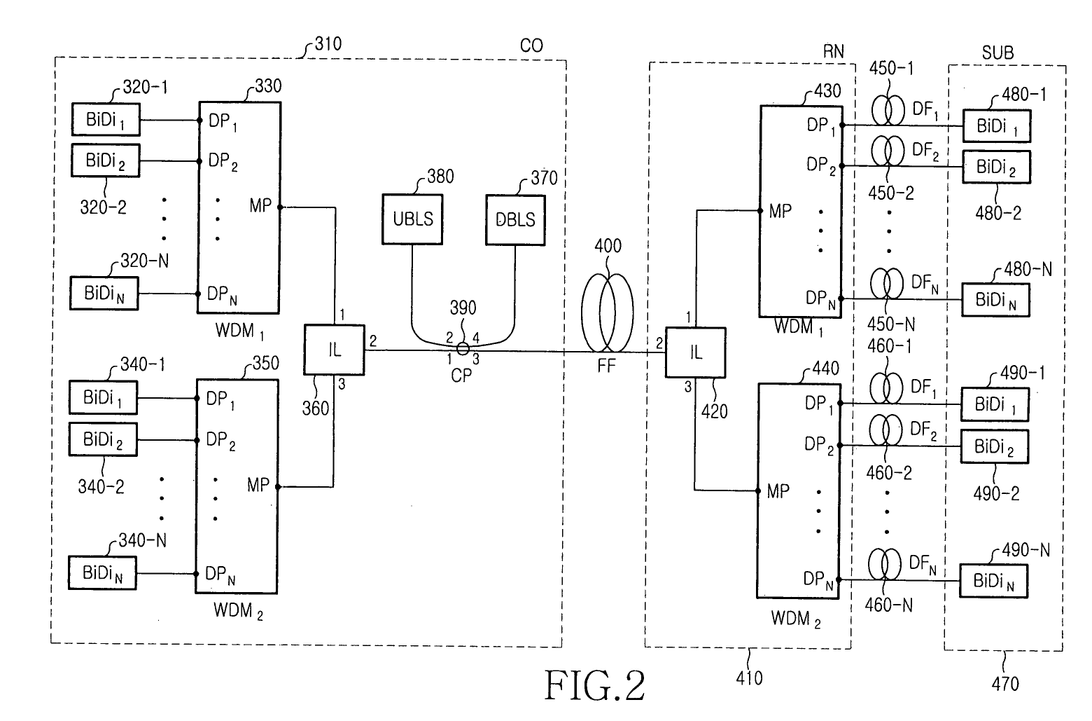

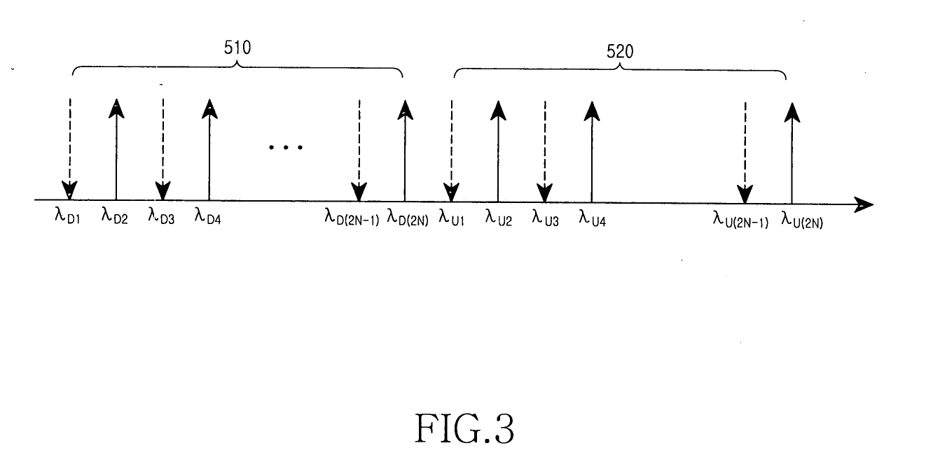

FIG. 2 is a block diagram illustrating a WDM PON according to an embodiment of the present invention, and FIG. 3 is a diagram illustrating downstream and upstream transmission bands used in the PON.

As shown, the PON 300 includes a Central Office (CO) 310, a Remote Node (RN) 410 connected to the CO 310 through an Feeder Fiber (FF) 400, and a subscriber-side device (SUB) 470 connected to the RN 410 through first to N^{th} Distribution Fibers (DFs) 450-1 to 450-N.

In operation, the CO 310 transmits downstream optical signals of a downstream wavelength band (downstream band) 510 to the RN 410 through the FF 400, and receives upstream optical signals of a upstream wavelength band 520 (upstream band) through the FF 400. The CO 310 includes first to N^{th} Bidirectional Optical Transceivers (BiDis) 320-1 to 320-N of a first group, first to N^{th} BiDis 340-1 to 340-N of a second group, first and second Wavelength Division Multiplexers (WDMs) 330 and 350, an interleaver (IL) 360, a Downstream Broadband Light Source (DBLS) 370, an Upstream Broadband Light Source (UBLS) 380, and an optical Coupler (CP) 390.

The first to the N^{th} BiDis 320-1 to 320-N of the first group are connected to the first WDM 330, receive first to N^{th} downstream injection light of a first group which belong to a first wavelength group of the downstream band 510, and output first to N^{th} data-modulated downstream optical signals of the first group generated by the first to the N^{th} downstream injection light of the first group. The first wavelength group of the downstream band 510 is comprised of downstream wavelengths λ_{D2}, λ_{D4}, . . . , λ_{D(2N)} in even sequences of the downstream band 510.

The first to the N^{th} BiDis 320-1 to 320-N of the first group receive first to N^{th} upstream optical signals of a first group which belong to a first wavelength group of the upstream band 520, and convert the first to the N^{th} upstream optical signals of the first group into electrical signals. The first wavelength group is comprised of upstream wavelengths λ_{U2}, λ_{U4}, . . . , λ_{U(2N)} in even sequences of the upstream band. The N^{th} BiDi 320-N receives N^{th} downstream injection light of a 2N^{th} downstream wavelength λ_{U(2N)}, outputs a N^{th} data-modulated downstream optical signal of the 2N^{th} downstream wavelength, which is generated by the N^{th} downstream injection light, and converts the N^{th} input upstream optical signal of the 2N^{th} upstream wavelength λ_{U(2N)} into an electrical signal.

Each of the BiDis 320-1 to 320-N may include a wavelength-locked optical transceiver such as a Fabry-Perot laser diode and a reflective semiconductor optical amplifier. A Fabry-Perot laser diode has a plurality of oscillation modes, and amplifies and outputs a mode coinciding with the wavelength of input downstream injection light. A reflective semiconductor optical amplifier has a gain curve of a broadband, and amplifies and outputs input downstream injection light.

The first WDM 330 is disposed so that the first to the N^{th} BiDis 320-1 to 320-N of the first group are connected to the interleaver 360. The first WDM 330 has a Multiplexing Port (MP) and first to N^{th} Demultiplexing Port (DPs). The MP is connected to the interleaver 360, and the first to the N^{th} DPs are sequentially connected to the first to the N^{th} BiDis 320-1 to 320-N of the first group in a one-to-one fashion. The first WDM 330 sequentially outputs the first to the N^{th} downstream injection light of the first group, which are input to the MP, through the first to the N^{th} DPs in a one-to-one fashion, multiplexes the first to the N^{th} downstream optical signals of the first group input to the first to the N^{th} DPs, outputs the first to the N^{th} multiplexed downstream optical signals through the MP, demultiplexes the first to the N^{th} upstream optical signals of the first group input to the MP, and sequentially outputs the first to the N^{th} demultiplexed upstream optical signals through the first to the N^{th} DPs in a one-to-one fashion. Herein, the first WDM 330 outputs the N^{th} downstream injection light and the N^{th} demultiplexed upstream optical signal through the N^{th} DP. The first WDM 330 may use a 1×N Arrayed Waveguide Grating (AWG).

The first to the N^{th} BiDis 340-1 to 340-N of the second group are connected to the second WDM 350, receive first to N^{th} downstream injection light of a second group which belong to a second wavelength group alternatively disposed with the first wavelength group within the downstream band 510, and output first to N^{th} data-modulated downstream optical signals of the second group generated by the first to the N^{th} downstream injection light of the second group.

The second wavelength group of the downstream band 510 is comprised of downstream wavelengths λ_{D1}, λ_{D3}, . . . , λ_{D(2N-1)} in odd sequences of the downstream band 510. The first to the N^{th} BiDis 340-1 to 340-N of the second group receive first to N^{th} upstream optical signals of a second group which belong to a second wavelength group alternatively disposed with the first wavelength group within the upstream band 520, and convert the first to the N^{th} upstream optical signals of the second group into electrical signals.

The second wavelength group of the upstream band 520 is comprised of upstream wavelengths λ_{U1}, λ_{U3}, . . . , λ_{U(2N-1)} in odd sequences of the upstream band 520. The N^{th} BiDi 340-N receives N^{th} downstream injection light of a (2N−1)^{th} downstream wavelength λ_{U(2N-1)}, outputs a N^{th} data-modulated downstream optical signal of the (2N−1)^{th} downstream wavelength, which is generated by the N^{th} downstream injection light, and converts the (2N−1)^{th} upstream optical signal of the (2N−1)^{th} upstream wavelength λ_{U(2N-1)} into an electrical signal. Each of the BiDis 340-1 to 340-N may include a wavelength-locked optical transceiver such as a Fabry-Perot laser diode and a reflective semiconductor optical amplifier.

The second WDM 350 is disposed so that the first to the N^{th} BiDis 340-1 to 340-N of the second group are connected to the interleaver 360. The second WDM 350 has a MP and first to N^{th} DPs. The MP is connected to the interleaver 360, and the first to the N^{th} DPs are sequentially connected to the first to the N^{th} BiDis 340-1 to 340-N of the second group in a one-to-one fashion. The second WDM 350 sequentially outputs the first to the N^{th} downstream injection light of the second group, which are input to the MP, through the first to the N^{th} DPs in a one-to-one fashion, multiplexes the first to the N^{th} downstream optical signals of the second group input to the first to the N^{th} DPs, outputs the first to the N^{th} multiplexed downstream optical signals through the MP, demultiplexes the first to the N^{th} upstream optical signals of the second group input to the MP, and sequentially outputs the first to the N^{th} demultiplexed upstream optical signals through the first to the N^{th} DPs in a one-to-one fashion. Herein, the second WDM 350 outputs the N^{th} downstream injection light and the N^{th} demultiplexed upstream optical signal through the N^{th} DP. The second WDM 350 may use a 1×N AWG.

The interleaver 360 is disposed so that the first and the second WDMs 330 and 350 are connected to the CP 390. The interleaver 360 has first to third ports. The first port is connected to the MP of the first WDM 330, the second port is connected to the CP 390, and the third port is connected to the MP of the second WDM 350. The interleaver 360 spectrum-slices and deinterleaves downstream light input to the second port, and then outputs the first to the N^{th} downstream injection light of the first group through the first port and outputs the first to the N^{th} downstream injection light of the second group through the third port. The interleaver 360 interleaves both the downstream optical signals of the first group input through the first port and the downstream optical signals of the second group input through the third port, and outputs the interleaved downstream optical signals of the first and the second groups through the second port. Further, the interleaver 360 deinterleaves the upstream optical signals of the first and the second groups input to the second port, and then outputs the upstream optical signals of the first group through the first port and outputs the upstream optical signals of the second group through the third port.

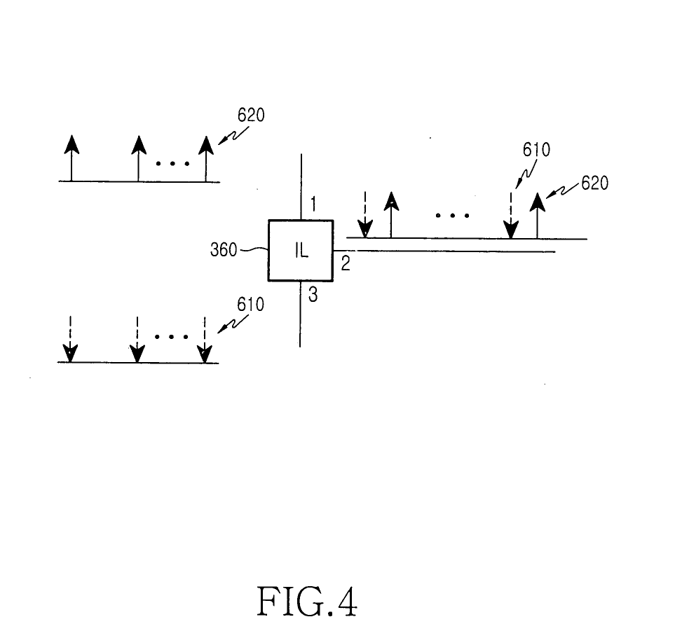

FIG. 4 is a diagram illustrating input and output characteristics of the interleaver 360. The interleaver 360 has the first to the third ports as described above. The first port functions as input and output paths of the even wavelengths 620, the second port functions as input and output paths of the even and odd wavelengths 620 and 610, and the third port functions as input and output paths of the odd wavelengths 610. The interleaver 360 deinterleaves optical signals input to the second port, and interleaves optical signals input to the first and the third ports.

The DBLS 370 is connected to the CP 390. The DBLS 370 outputs downstream light. The DBLS 370 may use an Erbium Doped Fiber Amplifier (EDFA), etc.

The UBLS 380 is connected to the CP 390. The UBLS 380 outputs upstream light. The UBLS 380 may use an EDFA, etc.

The CP 390 is disposed so that the DBLS 370 is connected to the second port of the interleaver 360, and the UBLS 380 is connected to the FF 400. The CP 390 has first to fourth ports. The first port is connected to the second port of the interleaver 360, the second port is connected to the UBLS 380, the third port is connected to the FF 400, and the fourth port is connected to the DBLS 370. The CP 390 outputs the upstream light, which is input to the second port, through the tnird port, outputs the downstream light, which is input to the fourth port, to the first port, outputs the downstream optical signals of the first and the second groups, which are input to the first port, through the third port, and outputs the upstream optical signals of the first and the second groups, which are input to the third port, through the first port.

The RN 410 deinterleaves and demultiplexes the downstream optical signals of the first and the second groups input through the FF 400, and transmits the demultiplexed downstream optical signals to the SUB 470 through the DFs 450-1 to 450-N and 460-1 to 460-N of the first and the second groups. The RN 410 spectrum-slices and deinterleaves the upstream light input through the FF 400 so as to generate the upstream injection light of the first and the second groups, and transmits the upstream injection light to the SUB 470 through the DFs 450-1 to 450-N and 460-1 to 460-N of the first and the second groups. The RN 410 multiplexes and interleaves the upstream optical signals of the first and the second groups input through the DFs 450-1 to 450-N and 460-1 to 460-N of the first and the second groups, and transmits the interleaved upstream optical signals to the CO 310 through the FF 400. Further, the RN 410 includes an interleaver 420 and first and second WDMs 430 and 440.

The interleaver 420 is disposed so that the FF 400 is connected to the first and the second WDMs 430 and 440. The interleaver 420 has first to third ports. The first port is connected to the first WDM 430, the second port is connected to the FF 400, and the third port is connected to the second WDM 440. The interleaver 420 spectrum-slices and deinterleaves the upstream light input to the second port, and then outputs the first to the N^{th} upstream injection light of the first group through the first port and outputs the first to the N^{th} upstream injection light of the second group through the third port. The interleaver 420 interleaves both the downstream optical signals of the first group input through the first port and the downstream optical signals of the second group input through the third port, and outputs the interleaved downstream optical signals of the first and the second groups through the second port. Further, the interleaver 420 deinterleaves the upstream optical signals of the first and the second groups input to the second port, and then outputs the upstream optical signals of the first group through the first port and outputs the upstream optical signals of the second group through the third port.

The first WDM 430 is disposed so that the first port of the interleaver 420 is connected to the DFs 450-1 to 450-N of the first group. The first WDM 430 has a MP and first to N^{th} DPs. The MP is connected to the first port of the interleaver 420, and the first to the N^{th} DPs are sequentially connected to the DFs 450-1 to 450-N of the first group in a one-to-one fashion. The first WDM 430 demultiplexes the first to the N^{th} upstream injection light of the first group, which are input to the MP, and sequentially outputs the first to the N^{th} demultiplexed upstream injection light through the first to the N^{th} DPs in a one-to-one fashion. The first WDM 430 multiplexes the first to the N^{th} upstream optical signals of the first group input to the first to the N^{th} DPs, and outputs the first to the N^{th} multiplexed upstream optical signals through the MP. The first WDM 430 demultiplexes the first to the N^{th} downstream optical signals of the first group input to the MP, and sequentially outputs the first to the N^{th} demultiplexed downstream optical signals through the first to the N^{th} DPs in a one-to-one fashion. Herein, the first WDM 430 outputs the N^{th} upstream injection light and the N^{th} downstream optical signal through the N^{th} DP. The first WDM 430 may use a 1×N AWG.

The second WDM 440 is disposed so that the third port of the interleaver 420 is connected to the DFs 460-1 to 460-N of the second group. The second WDM 440 has a MP and first to N^{th} DPs. The MP is connected to the third port of the interleaver 420, and the first to the N^{th} DPs are sequentially connected to the DFs 460-1 to 460-N of the second group in a one-to-one fashion. The second WDM 440 demultiplexes the first to the N^{th} upstream injection light of the second group, which are input to the MP, and sequentially outputs the first to the N^{th} demultiplexed upstream injection light through the first to the N^{th} DPs in a one-to-one fashion. The second WDM 440 multiplexes the first to the N^{th} upstream optical signals of the second group input to the first to the N^{th} DPs, and outputs the first to the N^{th} multiplexed upstream optical signals through the MP. The second WDM 440 demultiplexes the first to the N^{th} downstream optical signals of the second group input to the MP, and sequentially outputs the first to the N^{th} demultiplexed downstream optical signals through the first to the N^{th} DPs in a one-to-one fashion. Herein, the second WDM 440 outputs the N^{th} upstream injection light and the N^{th} downstream optical signal through the N^{th} DP. The second WDM 440 may use a 1×N AWG.

The SUB 470 transmits the upstream optical signals of the first and the second groups to the RN 410 through the DFs 450-1 to 450-N and 460-1 to 460-N of the first and the second groups, receives the upstream injection light of the first and the second groups through the DFs 450-1 to 450-N and 460-1 to 460-N of the first and the second groups, and receives the downstream optical signals of the first and the second groups through the DFs 450-1 to 450-N and 460-1 to 460-N of the first and the second groups. The SUB 470 includes first to N^{th} BiDis 480-1 to 480-N of a first group and first to N^{th} BiDis 490-1 to 490-N of a second group.

The first to the N^{th} BiDis 480-1 to 480-N of the first group are sequentially connected to the first to the N^{th} DFs 450-1 to 450-N of the first group in a one-to-one fashion. The first to the N^{th} BiDis 480-1 to 480-N of the first group receive the first to the N^{th} upstream injection light of the first group, output first to N^{th} data-modulated upstream optical signals of the first group generated by the first to the N^{th} upstream injection light of the first group, and convert the first to the N^{th} input downstream optical signals of the first group into electrical signals. The N^{th} BiDi 480-N receives N^{th} upstream injection light of a 2N^{th} upstream wavelength, outputs a N^{th} data-modulated upstream optical signal of the 2N^{th} upstream wavelength, which is generated by the N^{th} upstream injection light, and converts the N^{th} input downstream optical signal of the 2N^{th} downstream wavelength λ_{U(2N)} into an electrical signal. Each of the BiDis 480-1 to 480-N may include a wavelength-locked optical transceiver such as a Fabry-Perot laser diode and a reflective semiconductor optical amplifier.

The first to the N^{th} BiDis 490-1 to 490-N of the second group are sequentially connected to the first to the N^{th} DFs 460-1 to 460-N of the second group in a one-to-one fashion. The first to the N^{th} BiDis 490-1 to 490-N of the second group receive the first to the N^{th} upstream injection light of the second group, output first to N^{th} data-modulated upstream optical signals of the second group generated by the first to the N^{th} upstream injection light of the second group, and convert the first to the N^{th} input downstream optical signals of the second group into electrical signals. The N^{th} Bidi 490-N receives N^{th} upstream injection light of a (2N−1)^{th} upstream wavelength, outputs a N^{th} data-modulated upstream optical signal of the (2N−1)^{th} upstream wavelength, which is generated by the N^{th} upstream injection light, and converts the N^{th} input downstream optical signal of the (2N−1)^{th} downstream wavelength into an electrical signal. Each of the BiDis 490-1 to 490-N may include a wavelength-locked optical transceiver such as a Fabry-Perot laser diode and a reflective semiconductor optical amplifier.

According to a WDM PON of the present invention as described above, BiDis of first and second groups share one BLS by means of an interleaver, so that it is possible to accommodate many subscribers more economically and efficiently as compared with the prior art.

That is, according to the prior art, in order to increase the number of subscribers from N to 2N, a BLS must have a wavelength band increased by twice. Therefore, an additional BLS is necessary. However, according to the present invention, since an interleaving scheme is used, a BLS can maintain an initial wavelength band with no change even when the number of subscribers increases from N to 2N. Consequently, N additional BiDis and N existing BiDis can share an existing BLS.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof.

What is claimed is:

1. A Wavelength Division Multiplexed (WDM) Passive Optical Network (PON), comprising:
a Central Office (CO) for transmitting downstream optical signals;
a Remote Node (RN) for distributing the downstream optical signals received from the CO; and
a subscriber-side device (SUB) for receiving the distributed downstream optical signals,
wherein the CO includes:
a first group of a plurality of Bidirectional optical transceivers (BiDis) for outputting data-modulated downstream optical signals generated by downstream injection light;
a second group of a plurality of Bidirectional optical transceivers (BiDis) for outputting data-modulated downstream optical signals generated by downstream injection light;
a Downstream Broadband Light Source (DBLS) for outputting downstream light; and
an interleaver for generating the downstream injection light of the first and the second groups by spectrum-slicing and deinterleaving the downstream light, providing the downstream injection light to the BiDis of the first group, and providing the downstream injection light to the BiDis of the second group.

2. The WDM PON as claimed in claim 1, wherein the CO further comprises:
a first Wavelength Division Multiplexer (WDM) for demultiplexing the downstream injection light of the first group input from the interleaver; and
a second WDM for demultiplexing the downstream injection light of the second group input from the interleaver.

3. The WDM PON as claimed in claim 1, wherein each of the BiDis of the first and the second groups includes a Fabry-Perot laser diode or a reflective semiconductor optical amplifier.

4. The WDM PON as claimed in claim 1, wherein the CO further comprising a Upstream Broadband Light Source (UBLS) for outputting upstream light to be provided to the SUB.

5. The WDM PON as claimed in claim 4, wherein the RN comprises an interleaver for spectrum-slicing and deinterleaving the upstream light received from the CO so as to generate both upstream injection light of a first group, which belongs to a first wavelength group of an upstream band, and upstream injection light of a second group, which belong to a second wavelength group alternatively disposed with the first wavelength group more than twice within the upstream band, and providing the generated upstream injection light of the first and the second groups to the SUB.

6. The WDM PON as claimed in claim 5, wherein the SUB comprises:
a third group of BiDis for outputting data-modulated upstream optical signals generated by the upstream injection light received from the RN; and
a fourth group of BiDis for outputting data-modulated upstream optical signals generated by the upstream injection light received from the RN.

7. A Wavelength Division Multiplexed (WDM) Passive Optical Network (PON) having a Central Office (CO), a Remote Node (RN), and a subscriber-side device (SUB), comprising:
a plurality of first Bidirectional optical transceivers (BiDis) disposed in the CO for outputting downstream optical signals;
a plurality of second Bidirectional optical transceivers (BiDis) disposed the CO for outputting downstream optical signals;
a Downstream Broadband Light Source (DBLS) for outputting downstream light; and
an interleaver for spectrum-slicing and deinterleaving the downstream light in order to transmit downstream injection light to the first and second BiDis.

8. The WDM PON as claimed in claim 7, wherein the CO further comprises:
at least one Wavelength Division Multiplexer (WDM) for demultiplexing the downstream injection light from the interleaver and providing the demultiplexed downstream injection light to the first and second BiDis.

9. The WDM PON as claimed in claim 7, wherein each of the first and second BiDis includes a Fabry-Perot laser diode or a reflective semiconductor optical amplifier.

10. The WDM PON as claimed in claim 7, wherein the CO further comprising a Upstream Broadband Light Source (UBLS) for outputting upstream light to be provided to the SUB.

11. The WDM PON as claimed in claim 10, wherein the SUB comprises:
a third BiDis for outputting upstream optical signals generated by the upstream light received from the RN; and
a fourth BiDis for outputting upstream optical signals generated by the upstream light received from the RN.
